(19) United States
(12) Patent Application Publication
(10) Pub. No.: US 2021/0316229 A1
(43) Pub. Date: Oct. 14, 2021

(54) METHODS OF EXTRACTING CANNABINOIDS FROM CANNABIS INCLUDING FROM FRESH CANNABIS

(71) Applicant: BOLD GROWTH INC., Saskatoon (CA)

(72) Inventors: William Brent Robert POLLOCK, Saskatoon (CA); Kingsley Lawrence IROBA, Saskatoon (CA)

(21) Appl. No.: 17/228,485

(22) Filed: Apr. 12, 2021

Related U.S. Application Data
(60) Provisional application No. 63/009,000, filed on Apr. 13, 2020.

(51) Int. Cl. B01D 11/02; B01D 15/32

(52) U.S. Cl. CPC B01D 11/0288; B01D 15/325; B01D 11/0292

(57) ABSTRACT

Disclosed is methods of preparing a cannabinoid extract or cannabinoids from Cannabis biomass. The biomass can be at any degree of hydration, from damp with external water, to dried. The methods use a triacylglyceride (TAG) oil to extract cannabinoids into the TAG oil at +5° C. to +45° C. The enriched oil is then optionally further processed. If the TAG was either triacetin or tributyrin, the further processing can be done directly using reverse phase chromatography.

### FIELD OF THE INVENTION

This invention pertains generally to extraction of cannabinoids and, more particularly the extraction of cannabinoids from cannabis trichomes using triacylglycerides comprised of esters of saturated fatty acids in the two to ten carbon chain length range.

### BACKGROUND OF THE INVENTION

Cannabis and cannabis derived products have had a long history of medicinal use including use as an anticonvulsant, sedative, hypnotic, anti-depressant, analgesic, anti-inflammatory, anti-emetic, anti-spasmodic, and appetite-stimulator. The main medically active chemical compounds in cannabis are the phytocannabinoids (referred herein simply as cannabinoids). Plants in the genus Cannabis are unique in that they produce five cannabinoids enzymatically in their trichomes: cannabigerolic acid (CBGA; CAS 25555-57-1), cannabinerolic acid (CBRA; CAS 165134-19-0), Δ⁹-tetrahydrocannabinolic acid (THCA; CAS 23978-85-0), cannabidiolic acid (CBDA; CAS 1244-58-2) and cannabichromenic acid (CBCA; CAS 185505-15-1). All of these exist predominantly in their pentyl-tail versions (C₅; olivetols) but can also be found in their heptyl-(C₇; phorols), propyl-(C₃; varinols) and methyl-(C₁; orcinols) versions depending on the phenolic precursor that generated the CBGA or CBRA. A myriad of other cannabinoids can arise from this core group via non-enzymatic pathways. Best known and most significant is decarboxylation, but these can also involve slower pathways like dehydrogenation, oxygenation, hydroxylation, glycosylation, and isomerization driven by acid or ultra-violet light. The most renowned of these non-enzymatic derivatives are Δ⁹-tetrahydrocannabinol (THC; CAS 1972-08-3), cannabinol (CBN; CAS 521-35-7) and cannabidiol (CBD; CAS 13956-29-1). Cannabis trichomes also produce terpenoids but these are not unique to cannabis and are wide-spread in plants.

A number of cannabinoid-based pharmaceuticals have been approved for use in management of pain associated with multiple sclerosis and cancer, to treat poor appetite, nausea, sleep apnea, HIV/AIDS induced anorexia and chemotherapy induced nausea and vomiting. A CBD drug has also been approved to treat severe forms of epilepsy. CBD has also been shown to have anti-inflammatory properties that are potentially useful in the treatment of symptoms of arthritis.

Cannabinoids have previously been separated from the plant by extraction with organic solvents including hydrocarbons and alcohols. The solvents are flammable and many are toxic. Other extraction techniques are known in the art including the method disclosed in WO2020028991. WO2020028991 teaches cold extraction method for cannabinoids and terpenes from cannabis by polyunsaturated lipid-based solvents.

U.S. Pat. No. 9,732,009B2 teaches purifying a cannabinoid from dried cannabis, powdered cannabis, chopped cannabis, or ground cannabis with canola oil, tributylmethylammonium methyl sulfate, or 1-butyl -3-methylimidazolium chloride.

Most large-scale processing of cannabis to produce cannabinoids generally uses extraction by ethanol or supercritical carbon dioxide, sometimes in combination. These processing methods require that the cannabis be dried and usually dry-milled prior to extraction.

Drying of the cannabis requires manpower, time, warehousing, power & fuel. This drives costs up, can cause a severe bottleneck and lead to losses from microbial growth that overtakes the harvest before it can be dried.

There exists a need for a method of extracting cannabinoids, and other desirable trichome components from fresh cannabis (i.e. water still inside the plant). There further exists a need for an extraction method that accommodates visibly damp cannabis (i.e. harvested with rain, mist, ice, etc. on the outside of the plant); this water will be in direct contact with the extraction solvent. This method should ideally not require any engineering controls for flammability, vapors, removal of oxygen, excessive pressure gradients or extremes of temperature. Solvents used for extraction should be Generally Regarded as Safe (GRAS) by food and pharmaceutical regulatory agencies and suitable grades should be available in tonne quantities.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide methods of extracting cannabinoids from cannabis trichomes including fresh (i.e. water inside the plant) or visibly damp (i.e. water on the outside of the plant) cannabis. In accordance with an aspect of the present invention, there is provided a method of preparing a cannabinoid extract from this Cannabis biomass, the method comprising contacting the fresh or damp biomass with a triacylglyceride (TAG) oil to extract cannabinoids into the TAG oil to produce a mixture comprising the cannabinoid extract and biomass residue; and separating the cannabinoid extract from the biomass residue. Optionally, the TAG oil is a short chain triacylglyceride (SCT) oil or medium chain triacylglyceride (MCT) oil. In some embodiments, the TAG is Triacetin (TAn; CAS 102-76-1), Tributyrin (TBn; CAS 60-01-5), or liquid coconut oil (MCT Liquid; no CAS found, but usually refined from CAS 8001-31-8 or an equivalent) and combinations thereof.

In accordance with another aspect of the invention, there is provided a cannabinoid extract produced by the method of the invention.

In accordance with another aspect of the invention there is provided a method for purifying a cannabinoid from Cannabis biomass, the method comprising contacting the biomass with a SCT oil to extract cannabinoids into the SCT oil to produce a mixture comprising the cannabinoid extract and biomass residue; separating the cannabinoid extract from the biomass residue; optionally producing enriched cannabinoid extract by contacting the cannabinoid extract with additional Cannabis biomass and separating the enriched cannabinoid extract from biomass residue; and isolating the cannabinoid from the cannabinoid extract or enriched cannabinoid extract via reverse phase chromatography (RPC) to produce a purified cannabinoid. Optionally, the SCT oil used for extraction is Triacetin or Tributyrin. In some embodiments, recovery from the RPC medium is done with any desired combination of TAn, TBn, water, ethanol, 1-propanol, 2-propanol and MCT Liquid.

In accordance with another aspect of the invention, there is provided a cannabinoid produced by the method of the invention.

### BRIEF DESCRIPTION OF THE DRAWINGS

These and other features of the invention will become more apparent in the following detailed description in which reference is made to the appended drawings.

FIG. 1 is a flow diagram illustrating one embodiment of the extraction method of the invention.

FIG. 2 is a flow diagram illustrating one embodiment of the extraction method of the invention detailing timing of events.

FIG. 3 shows impact of mixing method and extraction solvent on reported total cannabinoid titre in undried bud.

FIGS. 4A and 4B show impact of vortex time and extraction solvent on reported total cannabinoid titre in undried bud.

FIG. 5 shows impact of external water and extraction solvent on reported total cannabinoid titre in undried bud.

FIG. 6 shows impact of extraction solvent and sampling statistics on reported total cannabinoid titre in undried bud.

FIGS. 7A, 7B, 7C and 7D show the TAn-Cannabis slurry after (a) milling, (b) initial centrifugation (TAn EXT layer on the bottom), and (d) more intensive centrifugation (left-hand tube ME02). Likewise, MCT Liquid slurry is shown after milling and (c) initial centrifugation (MCT Liquid EXT layer on the top), then (d) more intensive centrifugation (right-hand tube ME04).

FIG. 8 shows the UV-Vis absorbance spectra of the centrifuged extracts from FIGS. 7A-7D. ME02=TAn EXT. ME04=MCT Liquid EXT. The pure TAGs are also shown.

FIG. 9 shows the UV-Vis absorbance spectra of centrifuged TAn extract resulting from serial extractions, referred to in this figure as ME60. Fold-dilutions are shown in the inset legend. Note that the 10,000-fold dilution spectrum indicates highly pure THCA (and any spectrally similar CBGA & CBDA). It also shows relatively less pigmentation than the harsh milling conditions used in FIG. 8.

FIG. 10 shows RP-HPLC chromatograms (absorbance at 230 nm). Dashed ovals highlight the TAG peaks discussed in the text.

### DETAILED DESCRIPTION OF THE INVENTION

The invention provides methods of extracting bioactive compounds from fresh plant material. In particular, the invention provides methods of extracting cannabinoids from the trichomes of fresh cannabis biomass. More specifically, the invention provides methods for extracting and isolating compounds such as pure cannabinoids and cannabinoid acids by using triacylglyceride (TAG) oil as the extraction solvent to remove cannabinoid from any Cannabis spp. biomass that has a degree of hydration ranging through damp, undried, partially dried, to fully dried (<20% water by mass).

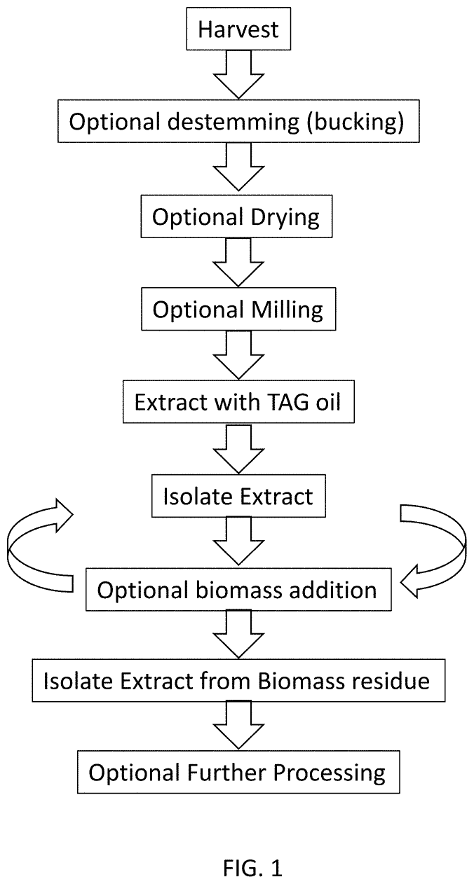

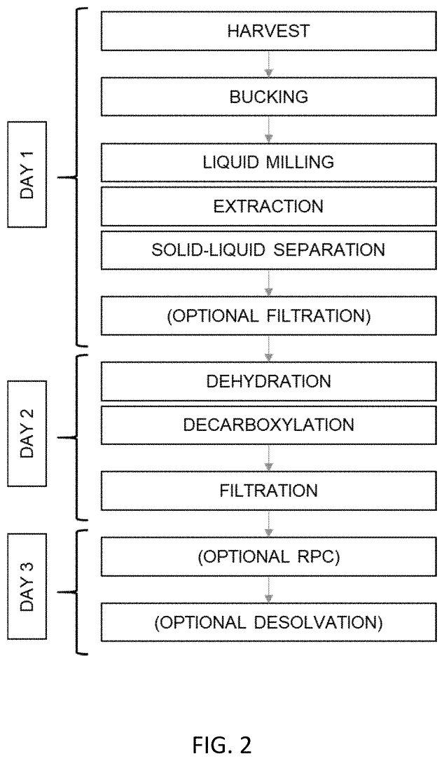

Referring to FIGS. 1 and 2, Cannabis biomass processed by the methods of the invention is generally freshly harvested including Cannabis harvested from outdoor fields or indoor facilities. Harvesting may be by hand or automated. Optionally, the Cannabis biomass is destemmed manually or with a bucking machine.

In some embodiments, harvested and optionally destemmed biomass is liquid-milled with the TAG oil extraction solvent. Liquid milling of the biomass may be a low-shear liquid milling (for example using a FrymaKoruma ML series Perforated Disc Mill). The milled biomass is optionally coarsely milled. In some embodiments, biomass is milled to provide a particle size between about 0.5 mm to about 5 mm.

The biomass is extracted with a TAG oil. During single-pass mixing operations, the ratio of TAG Oil to cannabis biomass should be no lower than 2 millilitres TAG oil per gram of cannabis biomass, preferably at least 5 mL/g. In some embodiments, the extraction is a serial extraction wherein the clarified solution of TAG oil and cannabinoids is recirculated for reuse as the extraction solvent: in this case the final ratio of TAG Oil to total cannabis biomass can be lower than 2 mL/g, preferably no lower than 0.02 mL/g. These numbers are predicated on the use of wet biomass with a titre of approximately 1.5% cannabinoid by weight, so the use of dry biomass would drive all these ratios up by approximately 10-fold.

In some embodiments, the TAG oil is a short chain triacylglyceride oil or medium chain triacylglyceride oil or combination thereof. Optionally, the TAG oil is selected from Triacetin (TAn), Tributyrin (TBn), MCT liquid coconut oil and combinations thereof.

In some embodiments, the extraction is a serial extraction wherein the extraction oil comprises cannabinoids. In some embodiments, extraction is with recirculated TAn.

The extraction is conducted at a temperature of between about +5° C. to about +45° C. The preferred range is +15° C. to +40° C. In some embodiments, heat exchangers are used in the fluid flow system to maintain the temperature in this range. Optionally, the oil is pre-heated to the extraction temperature.

The biomass/oil is optionally mixed or agitated to facilitate extraction. In some embodiments, mixing includes stirring, rocking, rotating, tumbling, vortex mixing, etc. Optionally, the period of mixing is the full extraction period. In alternative embodiments, the biomass/oil is mixed or agitated for an initial period and then the biomass is separated from extraction fluid.

The TAG oil is mixed with the biomass for a period of time that depends on the degree of agitation and bulk temperature. At the preferred temperature range of +15° C. to +40° C., homogenisation (particles <0.5 micron) can be done as fast as possible (e.g. <1 minute); coarse milling (roughly 0.5 to 5 mm) should include at least 1 minute of post-milling mixing; low-shear mixing should be done for at least 20 minutes. Static soaking is not recommended simply because it is too slow for manufacturing time and storage constraints.

The method can be adapted for large scale production of cannabinoid enriched oil.

In some embodiments of the method, biomass is harvested by a single cut to the main stalk. The stalk is connected to a conveyor system such that the plant is moved through a V-trough containing the TAG oil, optionally being pumped such that the TAG oil moves in the opposite to the direction the plant is moving. In some embodiments, the conveyer is set to rotate and/or bob the plant to improve mixing and contact with the TAG bath. After transit through the bath, the plant either is recirculated through a bath or is removed and disposed of. In some embodiments, the TAG oil is recirculated in the trough to increase the concentration of cannabinoids in the oil. Enriched oil is recovered and processed.

Alternatively, cannabis buds are immersed in the oil and circulated through the trough.

Following extraction, biomass residue is removed from the oil. In some embodiments, biomass is removed by filtration, sieving, gravity-drip conveyer belt or centrifugation followed by decanting of the cannabinoid enriched oil or combination thereof. In some embodiments, the cannabinoid enriched oil is used to extract cannabinoids from cannabis biomass thereby obtaining a further enriched or higher connection cannabinoid oil. In some embodiments, the cannabinoid enriched oil is flushed out of the biomass by a chase of water.

In some embodiments, water is removed from the cannabinoid enriched oil. Dewatering is optionally by gravity-drip conveyer belt, Super Absorbent Polymer (SAP; CAS 9003-04-7), centrifugal Liquid-Liquid separator (e.g. Rousselet Robatel RC30 with either a filter basket for TAGs with a density higher than water's, or decanter bowl for TAGs with a density lower than water's), or boiling.

The cannabinoids in the enriched oil are optionally decarboxylated by methods known in the art. In some embodiments, the enriched oil is heated and mixed. The oil temperature should always have a maximum that is at least 10° C. below the flash point of the TAG oil. In some embodiments, the enriched oil is heated to about +115° C. In alternative embodiments, the TAG oil is heated to a temperature of about +135° C. As is also known in the art, decarboxylation of cannabinoid acids follows first-order kinetics and therefore is never 100% complete, but does have a measurable half-life. In all cases, the aim is to use a combination of temperature and hold time that permits the minimum desired number of half-lives to elapse; the preferred hold time is at least eight half-lives.

In some embodiments, dewatering and decarboxylation are completed in a single step where the temperature of the oil is raised above the boiling point of water and the water evaporates. Use of oils that are less dense than water (e.g. MCT Liquid) risk bumping and spitting of submerged steam. In such embodiments, the TAG is preferably a SCT because they are denser than water.

The cannabinoid enriched oil is optionally filtered to remove particulates or contaminants. In some embodiments, the enriched oil is microfiltered to remove microbial contaminants larger than 0.2 μm. The filtered enriched oil may also then be nano-filtered to remove viruses.

The cannabinoids in the cannabinoid enriched oil are optionally refined from impurities (e.g. waxes and pigments). In some embodiments, refining of cannabinoids is by traditional methods such as dewaxing in frigid ethanol or reduction of terpenoids by short-path distillation. In embodiments using SCT oil as the extraction solvent, refining of cannabinoids can be done by reverse phase chromatography (RPC) without any need to remove the extraction solvent or dilute it with water.

Compounds isolated using the methods include Δ⁹-tetrahydrocannabinolic acid (THCA), cannabidiolic acid (CBDA), cannabigerolic acid (CBGA), and cannabichromenic acid (CBCA). Optionally, isolated compounds may be decarboxylated to Δ⁹-tetrahydrocannabinol (THC), cannabidiol (CBD), cannabigerol (CBG), and cannabichromene (CBC). These compounds are usually in the pentyl form but may also be in their analogous methyl (orcinols), propyl (varinols) or heptyl (phorols) forms.

To gain a better understanding of the invention described herein, the following examples are set forth. It will be understood that these examples are intended to describe illustrative embodiments of the invention and are not intended to limit the scope of the invention in any way.

### EXAMPLES

Extraction of Cannabinoids from C. Sativa Using TAGs

Overview:

These data show that the use of TAGs (triacylglycerides) composed of saturated chains in the C₂ to C₁₀ range were able to extract cannabinoids from undried biomass, they are also robust to the presence of water added to mimic damp biomass (e.g. freshly harvested during rain or snow). These data show that we should succeed with any of the three TAGs: Triacetin (TAn), Tributyrin (TBn) or liquid coconut oil (MCT). The highest cannabinoid concentration in any TAG extract seen in this study was 130 g THCA/L which is 5.8 times more concentrated than the 20 g THC/L typically seen in Cannabis oil products for sale under the current regulations.

Method:

Unless indicated otherwise, cannabinoids were extracted from mature, undried flowers from three C. sativa strains. The strains were all predominantly THCA strains: White Widow; Blue Venom; Motavation. Extraction TAG fluids were selected from triacetin, tributyrin, MCT Liquid (Medium Chain Triglycerides; TAGs that have fatty acyl chains in the range of 6 to 12 carbons in length), and olive oil at room temperature. Control extraction solvents were either methanol (MeOH) or ethanol (EtOH).

The extraction test combinations were mixed at room temperature for the time indicated. Mixing methods tested ranged from static soak, to hand mixing/twirling, and mechanical vortex mixing. Combinations were then centrifuged to separate plant debris from cannabinoid containing oil. Cannabinoid content was assessed by Reverse Phase-High Pressure Liquid Chromatography with detection by UV-Vis (RP-HPLC-DAD; quantification at 230 nm; silica-C18 RPC medium). Pigment content was done by scanning from 700 to at least 400 nm using a Cary 60 spectrophotometer.

Impact of Mixing Method & Extraction Solvent on Reported Total Cannabinoid Titre Extracted from Undried Bud

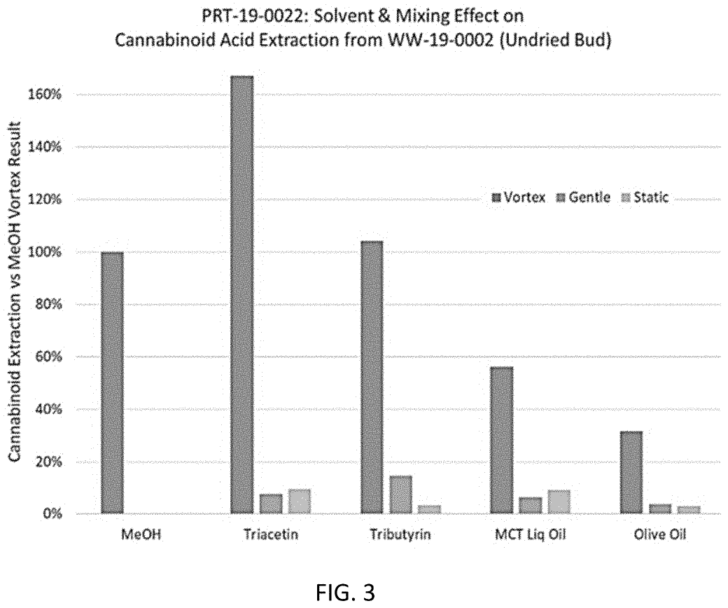

Cannabinoids were extracted from 0.1 g of undried White Widow 19-0002 buds using 10 mL of Triacetin (TAn), Tributyrin (TBn), liquid coconut oil (MCT), or olive oil. The results of the extraction were compared to extraction with methanol. The buds were statically soaked, gently mixed or vortex mixed from 1 minute at room temperature. Referring to FIG. 3, extraction efficiency with static soak or gentle mixing was poor compared to extraction using vortex mixing regardless of the solvent used. Extraction efficiency appeared to drop as the molecular weight of the TAG extraction solvent increased: MW TAn<TBn<MCT<Olive Oil likely due to viscosity limiting the diffusion.

Impact of Vortex Time & Extraction Solvent on Reported Total Cannabinoid Titre in Undried Bud

Cannabinoids were extracted from 0.5 g of undried Blue Venom 19-0011 buds using 5 mL of Triacetin (TAn), Tributyrin (TBn), or liquid coconut oil (MCT). The results of the extraction were compared to extraction with ethanol (EtOH). The buds were vortex mixed for 1, 2 or 5 min at room temperature and samples were taken at each time point.

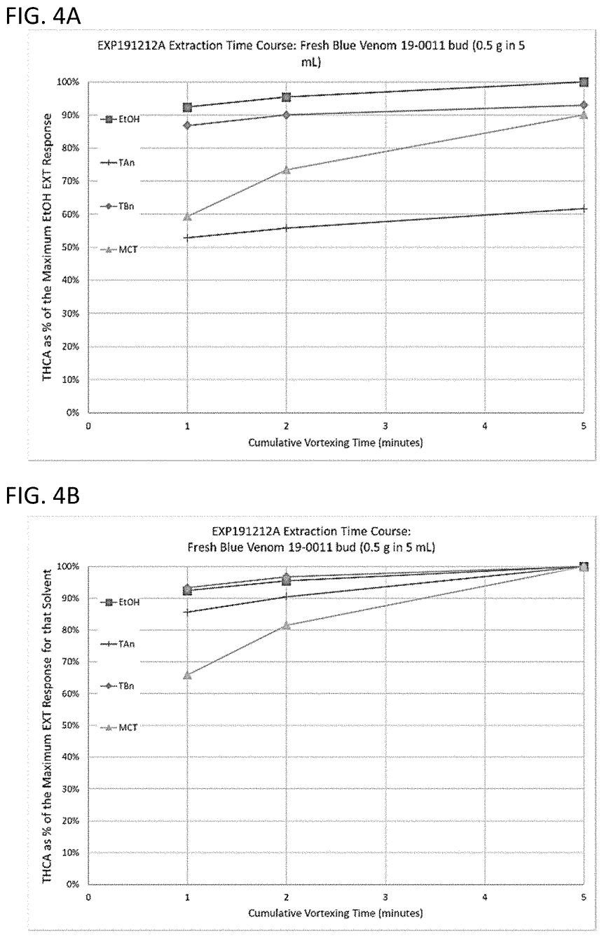

Referring to FIG. 4A, extraction with all three TAG tested were at least 50% as efficient as the alcohol control. When the data illustrated in FIG. 4A are normalized to show time course versus maximum concentration as shown in FIG. 4B, all TAGs tested were efficient at extracting cannabinoids, with MCT appearing to be slightly slower than SCTs. Comparing 2′ to 5′ vortex mixing time suggested that increased vortex was not necessary and suggests long contact times are not required.

Impact of Water & Extraction Solvent on Reported Total Cannabinoid Titre in Undried Buds.

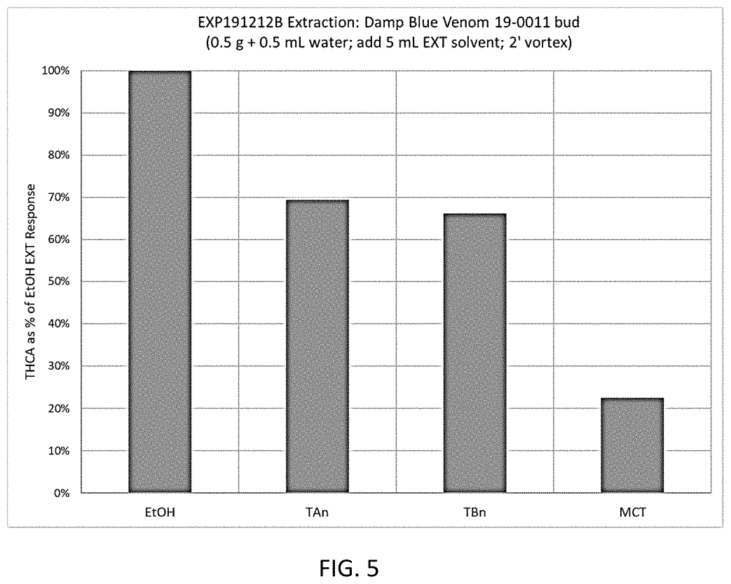

To assess the impact of external water on extraction (i.e. damp buds), 0.5 mL water was added to 0.5 g of undried Blue Venom 19-0011 buds, then 5 mL of ethanol (EtOH), Triacetin (TAn), Tributyrin (TBn), liquid coconut oil (MCT) was added as extraction solvent. The combinations were vortex mixed for 2 min at room temperature. Referring to FIG. 5, the SCTs were at least 50% as efficient as the alcohol control. Given that each experiment was only done once, these water-spike “damp” results seem no different from the un-spiked “undried” results in FIGS. 3 and 4A-4B. However, the impact of serial exposure to external water will be covered below in the example entitled PRODUCTION PROCESS TEST TUBE SCALE.

Impact of Improved Statistics on Reported Total Cannabinoid Titre in Undried Buds.

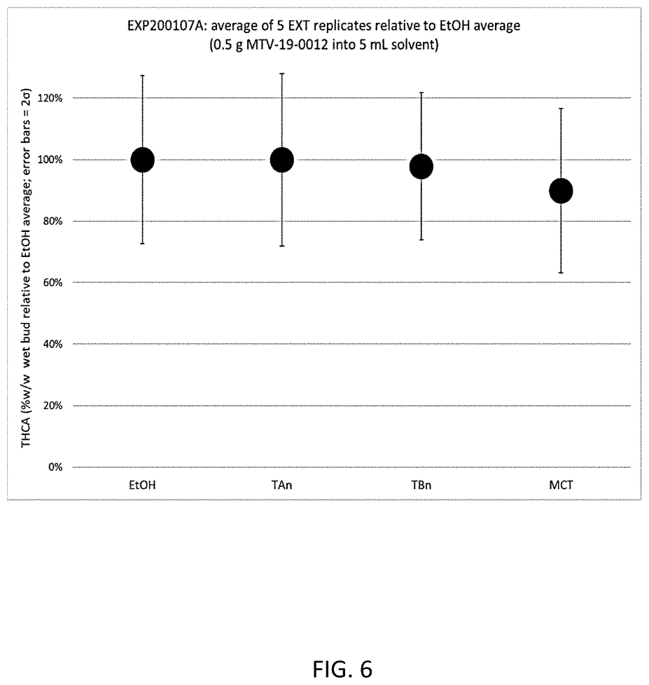

All previous data have been single experiments with small sample masses. To get a better statistical assessment of the impact of extraction solvent on the tire assessed for Motavation 19-0012 buds, 5 replicates of the following were done. Samples (0.5 g) of undried bud were extracted by vortex mixing for 2 minutes in 5 mL of ethanol (EtOH), Triacetin (TAn), Tributyrin (TBn), or liquid coconut oil (MCT). Referring to FIG. 6 it can be seen that all four are similar within two standard deviations. The averages suggest there is perhaps a slightly lower response from MCT but it is still a viable 90% relative to the others.

Liquid Milling

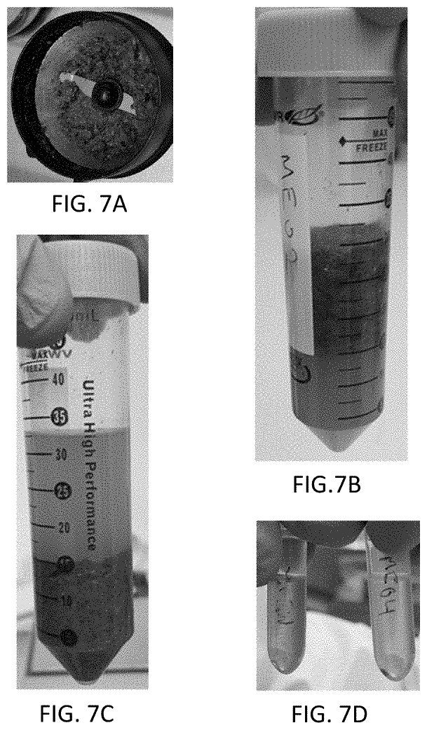

A standard home kitchen electric mill (e.g. typically used to grind coffee beans) was used to produce a TAG-Cannabis slurry. Originally, we tried the milling by combining the TAG with undried bud at 1 mL:1 g but it proved too thick to disperse for milling, so more TAG was added to give ratios of 1.9 (TAn) and 1.8 (MCT) mL:g. The resulting slurry (e.g. FIG. 7A) was still viscous but was easily separated by centrifugation (FIGS. 7B, 7C, and 7D). However, they were too viscous for the RP-HPLC autosampler and had to be diluted to about 2 g THCA/L for accurate sampling by that injector. The expected final concentration was around 11 g THCA/L so both TAGs gave full yield.

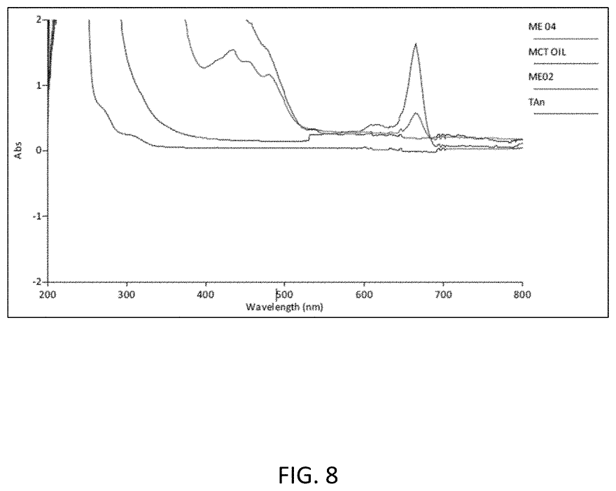

A Cary 60 UV-Vis spectrometer was used to assay the colouration of centrifugally clarified extracts. As can be seen from FIGS. 7B and 7C, the TAn sample appears greener than the MCT sample. This is supported by the absorbance of the two samples reported by the UV-Vis unit at 665 nm (red light, indicative of chlorophylls; FIG. 8 ME02=TAn centrate and ME04=MCT centrate). However, absolute colour is not as important as how much there is relative to the cannabinoid concentration. The simplest way to summarise that parameter is to convert the data to a “Colour Index”=A₆₆₅/[Cannabinoid in g/L]; we could call this the “Green-dex” because the absorbance at 665 nm is mainly due to chlorophyll. We want this Green-dex to be as close to nil as possible. As can be seen in the table, the TAn extract fluid is 2.6-times more coloured than the MCT extract fluid.

Liquid Milling as the Mixing Method for Extraction by TAn or MCT

| | | | | | A₆₆₅: |
|---|---|---|---|---|---|
| EXT | mL TAG to | | THCA titre | | [g THCA/L] |
| Solvent | g bud^{‡} | g THCA/L | % w/w | A₆₆₅ | (Green-dex) |
| TAn | 1.93 | 11.9 | 2.29 | 1.64 | 0.138 |
| MCT | 1.78 | 11.1 | 1.98 | 0.58 | 0.052 |

Production Process Test Tube Scale

At production scale we expect to recirculate the TAG fluid in a system that can be fed small sub-batches of the biomass. The spent biomass ballast is then removed from the recirculating, dilute slurry to make room for the next sub-batch. This keeps the instantaneous ratio of fluid to biomass quite high (aim is no lower than 5 mL TAG per g undried cannabis) even though the ratio of fluid to summed biomass might be quite low; this facilitates mixing because the overall final ratio of fluid to biomass is so low that it is almost impractical to mix, as was noted above in the Liquid Milling example.

To mimic the production process at test tube scale, an experiment was conducted wherein TAn extract fluid was transferred serially to a fresh tube which then received a new sub-lot of biomass. There was an average loss of 0.24 mL of TAn extraction fluid per tube transfer (a limitation of this small-scale method). This is 4.5% of the starting fluid volume, so after 20 transfers 4.6 mL (85% of the starting volume) was lost. Despite its extraction fluid volume shrinking at least 6.5-fold, the extraction was efficient and resulted in an overall THCA recovery of 1.16% w/w of the summed biomass. The concentration of THCA in this final extract was 138 g/L, which equates to 121 g THC/L. This TAn experiment was run against an ethanol control. The additional water eventually diluted the ethanol so much that it lost the capacity to dissolve cannabinoid: its final extraction efficiency was zero. This clearly demonstrated the ability of a TAG extraction solvent (in this case, TAn) to extract cannabinoid despite the presence of excessive water.

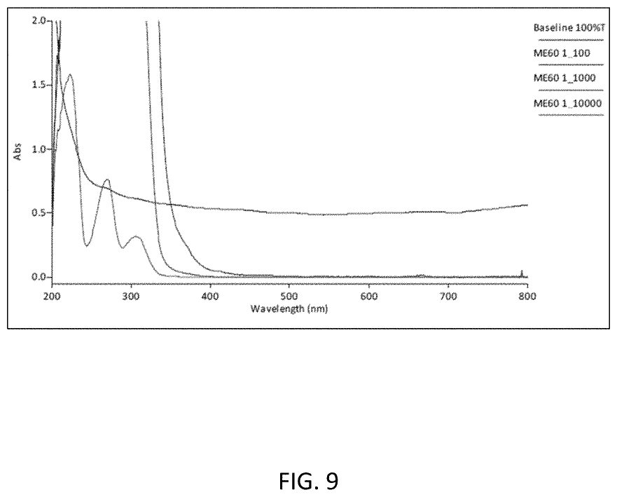

The centrifugally clarified (i.e. microfuged) TAn extract from this experiment was assayed by UV-Vis in the Cary 60; this is the ME60 sample in FIG. 9. The UV spectrum of its 10,000-fold dilution (ME60_10000) is extremely similar to that of THCA, indicating the extract is mostly THCA (and trace CBGA and CBDA, which have spectra similar to THCA). This TAn extract had a Green-Dex=0.0096 A₆₆₅: g THCA/L. Compared to the liquid-milled extracts of FIG. 7A-7D and FIG. 8, this is 14-fold less green than the TAn extract and 5-fold less green than the MCT extract. This shows that, as expected, aggressive milling leads to more impurity.

Comparison of Methanol & TAn as the Extraction Solvent From Dry Bud Biomass

| | | moles THCs |
|---|---|---|
| Lot ID | Sub- Lot ID | (% w/w) |
| Blood Orange Sorbet 19-0006 | TAn/MeOH | 89% |
| Mimosa 19-0006 | TAn/MeOH | 105% |
| Girl Scout Cookies 19-0006 | TAn/MeOH | 84% |
| All Three (Average) | TAn/MeOH | 93% |
| All Three (2σ) | TAn/MeOH | 23% |

The current regimen for preparing RP-HPLC assay samples from dried Cannabis is to extract 0.1 g twice with 10 mL of MeOH, assaying the combined 20 mL pool. While doing this for quintuplet samples of each batch shown in the table above, one sample of each quintuplet had a twin sample generated by a single extraction with 10 mL of TAn. The table shows the resulting ratio between the THCA assay result for the TAn vs Methanol. Given that the TAn extractions were done as a single 10 mL run rather than the 2×10 mL done with MeOH, and given the variability seen in FIG. 6, TAn is on pace for yields comparable to the alcohol extraction. These results indicate that TAG should work as a process-scale extraction fluid with dried Cannabis .

Reverse Phase Chromatography Observations

In addition to quantifying cannabinoids in the extracts, the RP-HPLC-DAD assay provides an indication that Reverse Phase Chromatography (RPC) could be used to isolate cannabinoids from TAn and TBn at manufacturing scale.

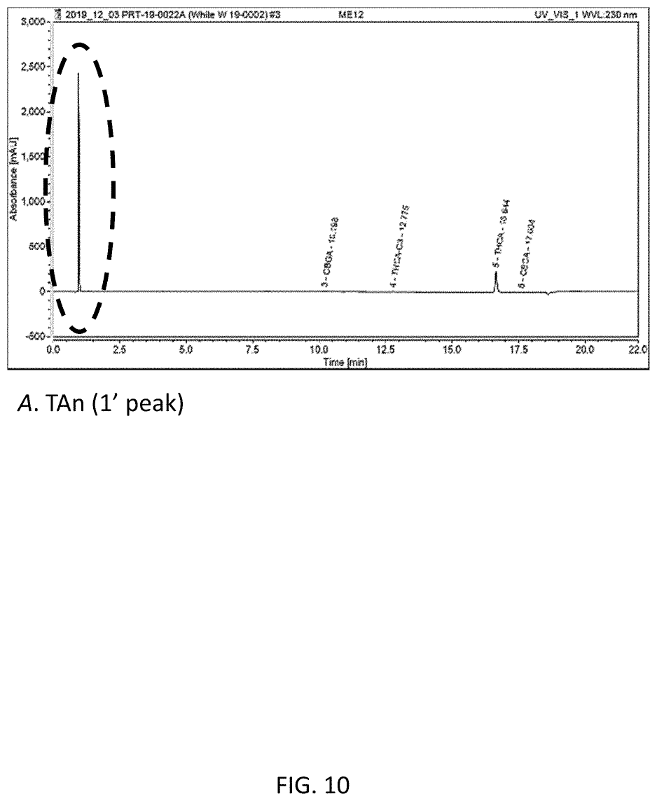

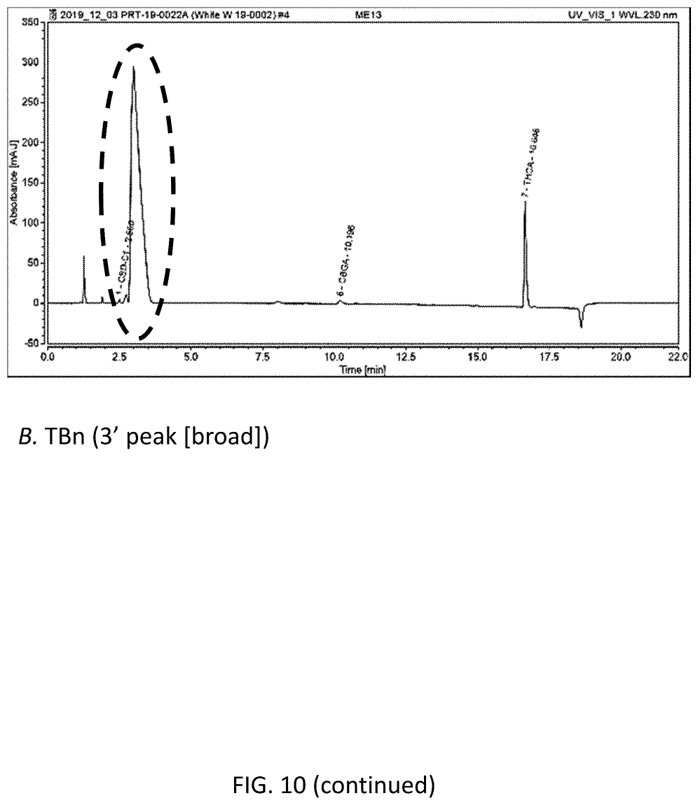

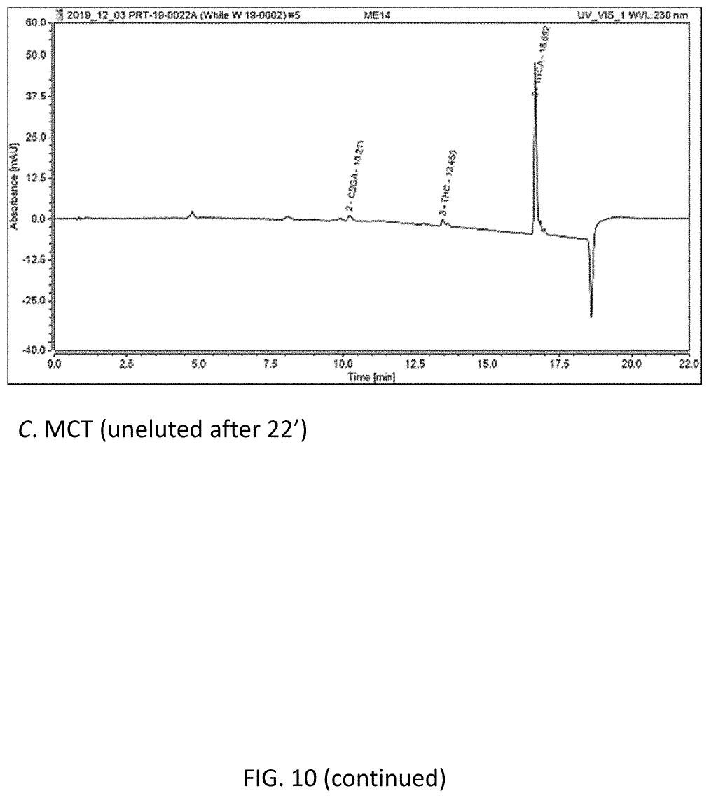

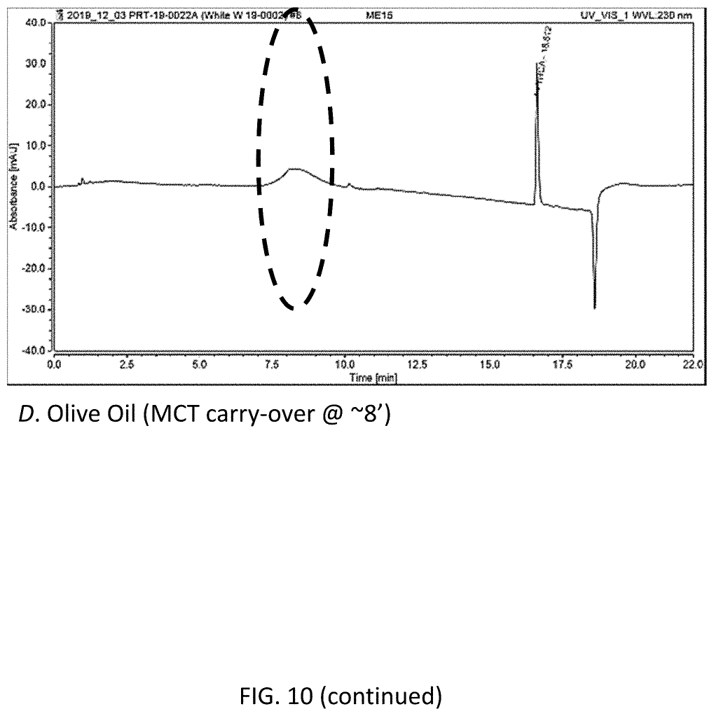

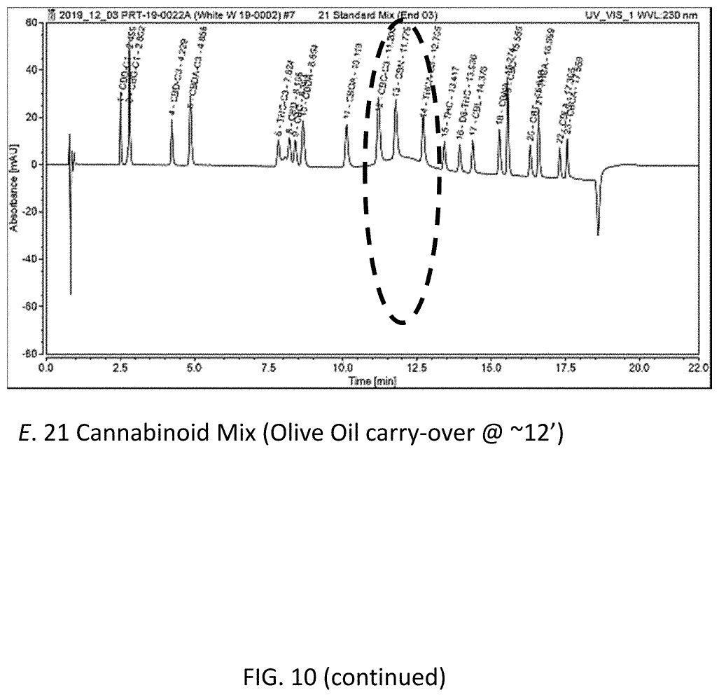

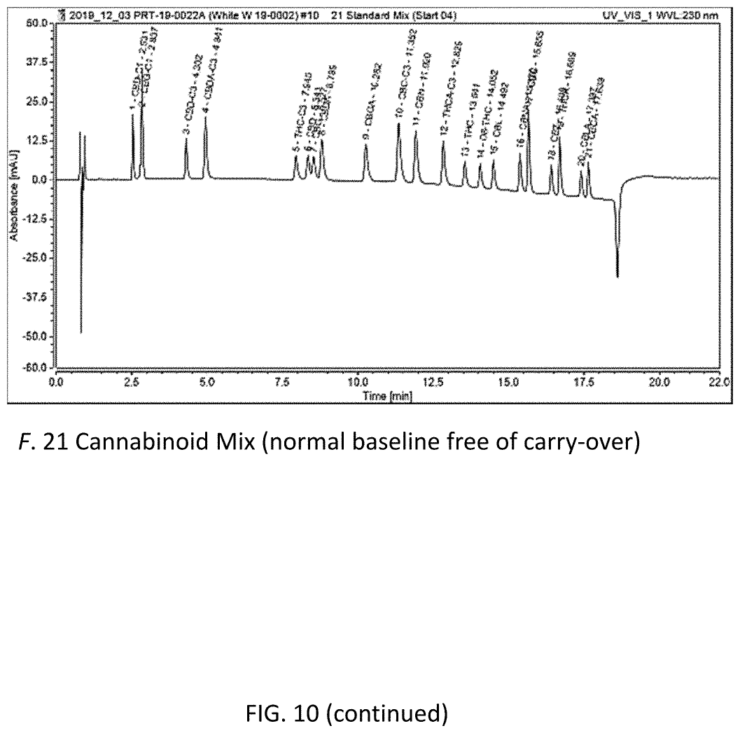

Referring to FIG. 10, normally, as can be seen in D (@ 8′; dashed oval) & E (@ 12′; dashed oval), TAGs like MCT and Olive Oil tend to bind so tightly to RPC media that they carry-over into the ensuing run, interfering as a bulge. The bulge caused by carry-over of Olive Oil is easily seen when comparing the baseline around 12′ in E to the normal baseline in F. This indicates that RPC cannot be used as a preparative method to isolate cannabinoids when they are dissolved in such highly lipophilic oils because the oil will push the cannabinoids off the RPC binding spots. This is also the case for other solvents routinely used for cannabinoid extraction: methanol, ethanol and propanol all outcompete cannabinoids for the binding spots unless enough water has been added to the mixture. Since the vegetable oils are not water miscible, the addition of water is not an option.

Surprisingly, both TAn and TBn do not show the same RPC behaviour as the vegetable oils. Instead, as can be seen in A (@ 1′; dashed oval) & B (@ 3′; dashed oval) both SCTs elute earlier than the cannabinoids with TAn not appearing to bind at all. This suggests that RPC media should be able to scrub cannabinoids out of large volumes of TAn and TBn. The cannabinoids could then be isolated by chasing the SCT out with a TAG oil like MCT Liquid or olive oil. Elution could also be via more traditional eluents like acetonitrile, methanol, ethanol, 1-propanol or 2-propanol, all of which can also be used in conjunction with water.

Optionally, the cannabinoids could also be concentrated in SCT by simply following up the load with an increasing ethanol gradient, then later evaporating the ethanol, leaving a SCT product that has much higher cannabinoid concentration. This alcohol-TAG combination could also be done with any of the combinations mentioned above.

Optionally, the preparative chromatographic equipment used to separate cannabinoids via Reverse Phase Chromatography could be medium resolution chromatography, high resolution separations, and even use eluents involving super-critical carbon dioxide (e.g. Novasep). Optionally, high-throughput configurations (e.g. Simulated Moving Bed) are used.

Although the invention has been described with reference to certain specific embodiments, various modifications thereof will be apparent to those skilled in the art without departing from the spirit and scope of the invention. All such modifications as would be apparent to one skilled in the art are intended to be included within the scope of the following claims.

We claim:

What is claimed is:

1. A method of preparing a cannabinoid extract from Cannabis spp. comprising:
a. providing Cannabis biomass comprising trichomes;
b. mixing or agitating the Cannabis biomass with a triacylglyceride (TAG) oil for a period of time thereby producing an oil comprising cannabinoid extract; and
c. recovering the oil from step (b) by separating it from the biomass; and
d. discarding the biomass.

2. The method of claim 1, wherein the TAG oil recovered in step (c) is reused as the TAG oil for extraction in step (b) in combination with a new, unextracted load of biomass in step (a).

3. The method of claim 1, wherein the TAG oil recovered in step (c) has its yield increased by displacement from the biomass with water.

4. The method of claim 1, wherein the TAG oil is a short chain triacylglyceride oil.

5. The method of claim 4, wherein the TAG oil is selected from Triacetin (TAn) or Tributyrin (TBn).

6. The method of claim 1, wherein the TAG oil is a medium chain triacylglyceride oil. The method of claim 6, wherein the TAG oil is MCT Liquid oil.

8. The method of claim 1, wherein the TAG oil is a combination of short chain triacylglyceride oil and medium chain triacylglyceride oil.

9. The method of claim 1, wherein the Cannabis biomass is damp with external water.

10. The method of claim 1, wherein the Cannabis biomass is undried.

11. The method of claim 1, wherein the Cannabis biomass is partially dried.

12. The method of claim 1, wherein the Cannabis biomass is dried.

13. The method of claim 1, wherein the TAG oil is at a temperature between +5° C. to +45° C.

14. The method of claim 13, wherein the TAG oil is preferably at +15° C. to +40° C.

15. The method of claim 1, wherein the mixing or agitating is vortex mixing for at least 2 minutes.

16. The method of claim 1, wherein the mixing or agitating is via liquid milling to a particle size no greater 5 mm with post-mill mixing for at least 1 minute.

17. A cannabinoid extract produced by the method of claim 1.

18. The method of claim 1, comprising removing the water from the cannabinoid extract until it has no visible aqueous phase.

19. The method of claim 18, wherein the step of removing water is gravity-drip conveyer belt, Super Absorbent Polymer (SAP; CAS 9003-04-7), or centrifugal Liquid-Liquid separator.

20. The method of claim 18, wherein the step of removing water comprises boiling off as the initial step in decarboxylation of the cannabinoid acids.

21. A decarboxylated cannabinoid extract produced by the method of claim 20.

22. The method of claim 17 further comprising decreasing the level of impurities in the cannabinoid extract.

23. The method of claim 22 wherein the extraction solvent only comprised TAn, TBn, or combination thereof.

24. The method of claim 23 wherein the cannabinoids have the impurities decreased by separation through a reverse phase chromatography medium.

25. A refined cannabinoid extract produced by the method of claim 24.
